(19) United States
(12) Patent Application Publication
(10) Pub. No.: US 2009/0052853 A1
(43) Pub. Date: Feb. 26, 2009

(54) Holey fiber and method of manufacturing the same

(75) Inventors: Kazunori MUKASA, Tokyo (JP); Ryuichi Sugizaki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: THE FURUKAWA ELECTRIC CO., LTD., Tokyo (JP)

(21) Appl. No.: 12/129,257

(22) Filed: May 29, 2008

(30) Foreign Application Priority Data
Jun. 5, 2007 (JP) 2007-149469
Feb. 13, 2008 (JP) 2008-031465

(51) Int. Cl. G02B 6/02; G02B 6/00; C03B 7/01

(52) U.S. Cl. 385/125; 264/1.24; 65/533

(57) ABSTRACT

A holey fiber includes a core region and a cladding region surrounding the core region and having air holes arranged around the core region. The cladding region includes an inner cladding layer surrounding the core region and an outer cladding layer surrounding the inner cladding layer. Furthermore, viscosities of the core region and the inner cladding layer are set lower than a viscosity of the outer cladding layer.

### BACKGROUND OF THE INVENTION

1. Field of the Invention

The present invention relates to a holey fiber and a method of manufacturing the same.

2. Description of the Related Art

A holey fiber is an optical fiber having air holes arranged in a periodic manner in a cladding region. The cladding region surrounds a core region. The cladding region has reduced average refractive index because of the presence of the air holes so that a light passes almost entirely through the core region because of the total reflection of the light.

Because the refractive index of holey fibers can be controlled by controlling various parameters of the air holes, the holey fibers can realize unique properties that can not be realized in the other optical fibers such as endlessly single mode (ESM) and anomalous dispersion at a short wavelength. The ESM means that a cut-off wavelength is not present and a light is transmitted in a single mode at all wavelengths. With the ESM, it is possible to realize an optical transmission at a high transmission speed over a broadband. For example, a result of an experiment of a dispersion-managed soliton transmission at a transmission speed of 10 Gb/s by forming an optical path of 100 kilometers by combining the holey fiber and a dispersion compensating optical fiber is disclosed in K. Kurokawa, et al., “Penalty-Free Dispersion-Managed Soliton Transmission over 100 km Low Loss PCF”, Proc. OFC PDP21 (2005).

Meanwhile, for realizing long-haul transmission, it is necessary that holey fibers have low transmission loss. For example, a holey fiber with low transmission loss of 0.28 dB/km is disclosed in K. Tajima, et al., “Low water peak photonic crystal fibres”, ECOC'03 PD Th4.16 (2003).

Holey fibers are manufactured by drawing a preform. The preform is made of silica glass and holes are formed in the preform by stack-and-draw method, drill method, or sol-gel method. Shapes of the air holes can disadvantageously deform during the drawing process. A technology for preventing deformation of shapes of air holes during the drawing process is disclosed in, for example, Japanese Patent Application Laid-open No. 2006-83003. Specifically, the preform is drawn at a relatively low temperature and the pressure of inert gas is controlled precisely.

Holey fibers used for long-haul transmission needs to have low transmission loss, and the air holes need to have uniform shapes over a considerable length.

However, if the drawing process is performed at a low temperature, stress is applied to the core region and the air holes due to excess tension generated in the drawing process. Such stress can lead to glass defect and distortion of surfaces of the air holes, which in turn leads to increase in transmission loss. On the other hand, if the drawing process is performed at a relatively high temperature, it is necessary to precisely control gas pressure to maintain the shapes of the air holes. Thus, more complicated manufacturing processes are necessary.

### SUMMARY OF THE INVENTION

It is an object of the present invention to at least partially solve the problems in the conventional technology.

According to an aspect of the present invention, there is provided a holey fiber that includes a core region; and a cladding region surrounding the core region and having air holes arranged around the core region, the cladding region including an inner cladding layer surrounding the core region and an outer cladding layer surrounding the inner cladding layer. Viscosities of the core region and the inner cladding layer are lower than a viscosity of the outer cladding layer.

According to another aspect of the present invention, there is provided a method of manufacturing a holey fiber including a core region and a cladding region surrounding the core region and having air holes arranged around the core region. The method includes forming a preform by arranging a core rod at a center of a jacket tube and inner capillary tubes around the core rod; and drawing the preform. Viscosities of the core rod and the inner capillary tubes are lower than a viscosity of the jacket tube.

According to still another aspect of the present invention, there is provided a method of manufacturing a holey fiber including a core region and a cladding region surrounding the core region and having air holes arranged around the core region. The method includes forming a preform with air holes arranged in a region of a glass rod, the glass rod having an inner layer and an outer layer with a viscosity higher than a viscosity of the inner layer, and the region being other than a center region of the inner layer; and drawing the preform.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a holey fiber according to an embodiment of the present invention;

FIG. 2 is a schematic diagram of a preform for manufacturing the holey fiber shown in FIG. 1;

FIG. 3 is a schematic diagram for explaining a method of manufacturing the holey fiber shown in FIG. 1;

FIG. 4 is a table containing data of characteristics of the holey fiber shown in FIG. 1 calculated by a Finite Element Method (FEM) simulation at a wavelength of 1550 nanometers with a parameter d/Λ of 0.50 where d is a hole diameter and Λ is an air hole pitch of 10 micrometers;

FIG. 5 is a graph of chromatic dispersion verses wavelength of the holey fiber shown in FIG. 4;

FIG. 6 is a schematic diagram of an optical field distribution in the holey fiber shown in FIG. 4;

FIG. 7 is a table containing data of characteristics of holey fibers according to Example 1 and Comparative Example 1 of the present invention;

FIG. 8 is a graph of transmission loss verses wavelength of the holey fibers shown in FIG. 7; and

FIG. 9 is a graph of a relationship between density of Ge in a glass rod and a capillary tube and transmission loss at a wavelength of 1550 nanometers for each of holey fibers according to Examples 2 to 4 and Comparative Example 2 of the present invention.

### DETAILED DESCRIPTION OF THE PREFERRED EMBODIMENTS

Exemplary embodiments of the present invention are explained in detail below with reference to the accompanying drawings. The present invention is not limited to the below embodiments.

Silica glass without dopant is referred to as pure silica glass in this document. Furthermore, bending loss is calculated under such a condition that an optical fiber is wound 16 times at a bending diameter of 20 millimeters. Moreover, a cut-off wavelength λc defined by International Telecommunication Union Telecommunication Standardization Sector (ITU-T) G.650.1 is employed. Other terms and methods are also used based on definitions and test methods defined by ITU-T G.650.1 unless otherwise specified in this document.

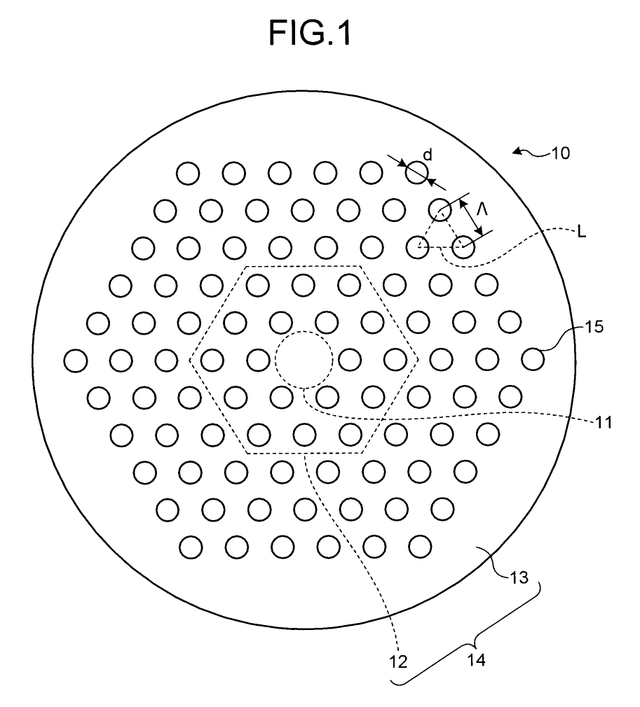

FIG. 1 is a schematic diagram of a holey fiber 10 according to an embodiment of the present invention. The holey fiber 10 includes a core region 11 at a center of the holey fiber 10 and a cladding region 14 surrounding the core region 11. The cladding region 14 includes an inner cladding layer 12 surrounding the core region 11 and an outer cladding layer 13 surrounding the inner cladding layer 12. The cladding region 14 contains air holes 15 around the core region 11 in a layered structure. A first layer and a second layer of the air holes 15, counted from the core region 11, are formed within the inner cladding layer 12 and a third to a fifth layers of the air holes 15 from the core region 11 are formed within the outer cladding layer 13.

The air holes 15 are arranged in a triangular lattice L within the layered structure. A diameter of each of the air holes 15 is represented by “d” and a lattice constant of the triangular lattice L, that is, a pitch between centers of the air holes 15 is represented by “A”. Characteristics of the holey fiber 10 can be controlled by adjusting values of Λ and/or d/Λ.

The core region 11 and the inner cladding layer 12 are made of Chlorine (Cl)-doped silica glass and the outer cladding layer 13 is made of pure silica glass. When silica glass is manufactured by using Cl, residual trace Cl may be doped into the silica glass. However, when the amount of Cl doped into the silica glass is sufficiently small, that is, when increase in a refractive index of the silica glass to undoped silica glass by residual trace Cl is 0.005% or less, the silica glass is considered as the pure silica glass. The amount of Cl doped in the Cl-doped silica glass of the core region 11 and the inner cladding layer 12 is far larger than that of the pure silica glass of the outer cladding layer 13. That is, viscosities of the core region 11 and the inner cladding layer 12 are lower than a viscosity of the outer cladding layer 13. Therefore, stress due to excess tension at the time of a drawing process is mainly applied to the outer cladding layer 13 and less stress is applied to the core region 11 and the inner cladding layer 12 in which a light propagates. Thus, glass defect and distortion of surfaces of air holes in a region in which a light propagates can be reduced. As a result, the holey fiber 10 has low transmission loss.

An optical field of a light that propagates in the holey fiber 10 encompasses the core region 11 and the first and the second layers of the air holes 15. However, because the holey fiber 10 is formed such that the first and the second layers of the air holes 15 are within the inner cladding layer 12, it is possible to sufficiently prevent transmission loss of a propagating light due to glass defect and the like.

Instead of Cl, germanium (Ge) or fluorine (F) can be doped into the core region 11 and the inner cladding layer 12. Among Cl, Ge, and F, Cl is more preferable because the viscosities of the core region 11 and the inner cladding layer 12 can be more reduced with Cl than with Ge and F and a refractive index of silica glass can be maintained substantially constant even with Cl. A relationship among a density of dopant, relative refractive index difference Δ to pure silica glass, and a viscosity is described below with respect to each dopant. When a density of Ge is 0.5 mol % or more, Δ becomes 0.05% or more and a glass viscosity at 1200° C. (log(η1200)) becomes 13 poises or less (see, for example, Kawazoe, et al., Handbook for Application of Amorphous Silica, Realize Inc., Japan, 1999). On the other hand, when a density of F is such that an absolute value of changing Δ by F is about 0.33 times larger than a value of changing Δ by Ge, substantially the same glass viscosity as that with the Ge can be attained. As for Cl, even a density of Cl is such that a value of changing Δ by Cl is about 0.17 times larger than a value of changing Δ by Ge, substantially the same glass viscosity as that with the Ge can be attained.

Moreover, one or more types of dopant can be doped into the core region 11 and the inner cladding layer 12. That is, two or more selected from Cl, Ge, and F can be doped. For example, if Ge and F are doped together into the core region 11 and the inner cladding layer 12, the viscosities of the core region 11 and the inner cladding layer 12 can be effectively reduced due to effects of Ge and F. Furthermore, by adjusting doping ratio of Ge and F, Δ can be set to a predetermined value such as 0%.

The core region 11 and the inner cladding layer 12 can be made of materials of which a viscosity is adjusted by varying the method of manufacture. The viscosities of the core region 11 and the inner cladding layer 12 can be the same. However, it is more preferable to set the viscosity of the core region 11, in which a large part of a light propagates, to be lower than that of the inner cladding layer 12.

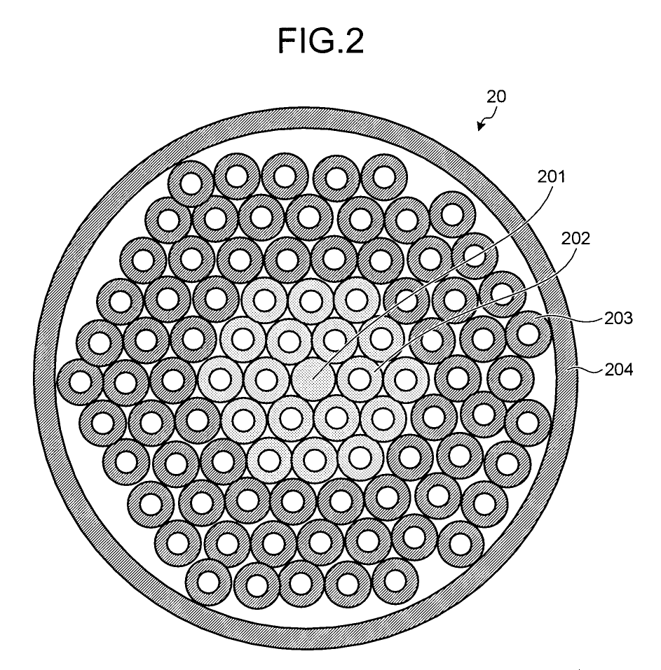

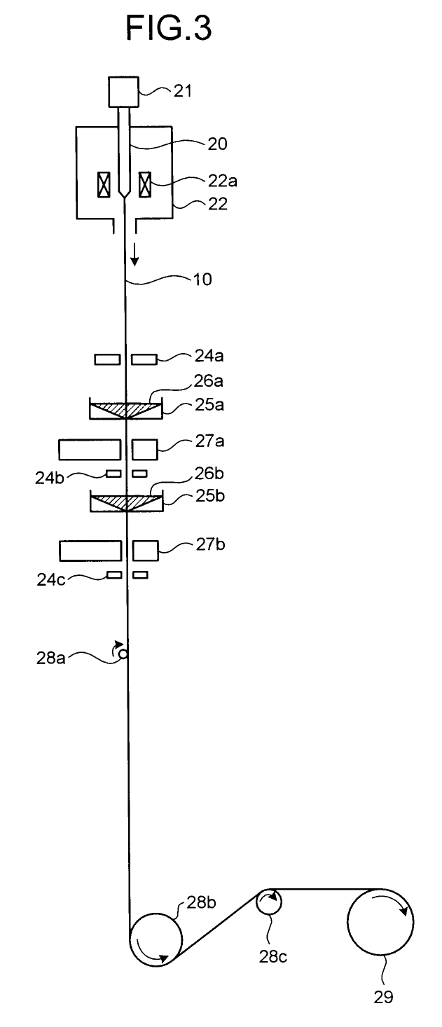

A method of manufacturing the holey fiber 10 by the stack and draw method is described with reference to FIGS. 2 and 3.

A preform 20 for manufacturing the holey fiber 10 is formed as explained below. FIG. 2 is a schematic diagram of the preform 20. A core rod 201 as a solid core made of Cl-doped silica glass for forming the core region 11 is arranged. Inner capillary tubes 202 having hollows at the center and made of Cl-doped silica glass for forming the inner cladding layer 12 and the air holes 15 are arranged around the core rod 201. Outer capillary tubes 203 having hollows at the center and made of pure silica glass for forming the outer cladding layer 13 and the air holes 15 are arranged around the inner capillary tubes 202. The core rod 201, the inner capillary tubes 202, and the outer capillary tubes 203 are bundled and accommodated in a hollow of a jacket tube 204 made of pure silica glass. Diameters and inner diameters of the core rod 201, the inner capillary tubes 202, the outer capillary tubes 203, and the jacket tube 204, and the number of the inner capillary tubes 202 and the outer capillary tubes 203 are determined depending on diameters of the air holes, air hole pitch, and number of layers to be obtained.

A distal end of the preform 20 is melted to collapse holes of the inner capillary tubes 202 and the outer capillary tubes 203, and the preform 20 is set to a draw tower 22 shown in FIG. 3. A gas pressure device 21 is connected to an unmelted end of the preform 20.

The distal end of the preform 20 is heated to be melted by a heater 22a to draw the holey fiber 10. During a drawing process of drawing the holey fiber 10, the gas pressure device 21 applies pressure to insides of the holes of the inner capillary tubes 202 and the outer capillary tubes 203 to maintain shapes of air holes. At this state, viscosities of the outer capillary tubes 203 and the jacket tube 204 are higher than viscosities of the core rod 201 and the inner capillary tubes 202 in the preform 20. As a result, stress generated during the drawing process is mainly applied to the outer capillary tubes 203 and the jacket tube 204, and less stress is applied to the core rod 201 and the inner capillary tubes 202. Thus, even when the holey fiber 10 is drawn at a relatively low temperature, glass defect and distortion of the surface of air holes can be reduced in a region of the holey fiber 10 in which a light propagates. Furthermore, because the holey fiber 10 can be drawn at a relatively low temperature, deformation of air holes can be easily prevented without improving control precision of gas pressure to be applied. As a result, the holey fiber 10 with low transmission loss can be easily manufactured.

As described above, pressure is applied to the inside of the holes of the capillary tubes to control shapes of air holes. However, the shapes of the air holes can be controlled by forming a vacuum in the insides of the holes of the capillary tube. Furthermore, it is possible to control the shapes of the air holes by controlling a temperature of the heater and a drawing speed.

An outer-diameter measuring device 24a measures an outer diameter of the drawn holey fiber 10, a resin applying device 25a applies ultraviolet curable resin 26a as an inner coating layer on an outer periphery of the holey fiber 10, an ultraviolet applying device 27a causes the ultraviolet curable resin 26a to be cured with ultraviolet rays, and an outer-diameter measuring device 24b measures an outer diameter of the inner coating layer. Similarly, a resin applying device 25b applies ultraviolet curable resin 26b as an outer coating layer on an outer periphery of the inner coating layer, an ultraviolet applying device 27b causes the ultraviolet curable resin 26b to be cured with ultraviolet rays, and an outer-diameter measuring device 24c measures an outer diameter of the outer coating layer. The holey fiber 10 coated with layers formed in the above manner is guided by guide rollers 28a to 28c, and wound up by a take-up spool 29.

As Example 1, a holey fiber having the same structure as that of the embodiment was manufactured by the stack and draw method. A glass rod and capillary tubes for forming air holes on the first and the second layers from the glass rod were made of Cl-doped silica glass. The amount of Cl to be doped was set so that relative refractive index difference Δ of the glass rod and the capillary tubes to pure silica glass was 0.05%. Other capillary tubes and the jacket tube were made of pure silica glass. On the other hand, as Comparative Example 1, a holey fiber having the same structure as that of the Example 1 was manufactured by the stack and draw method using a glass rod, capillary tubes, and jacket tubes made of pure silica glass. Both the holey fibers were drawn in a low temperature region such as at around 1870° C.

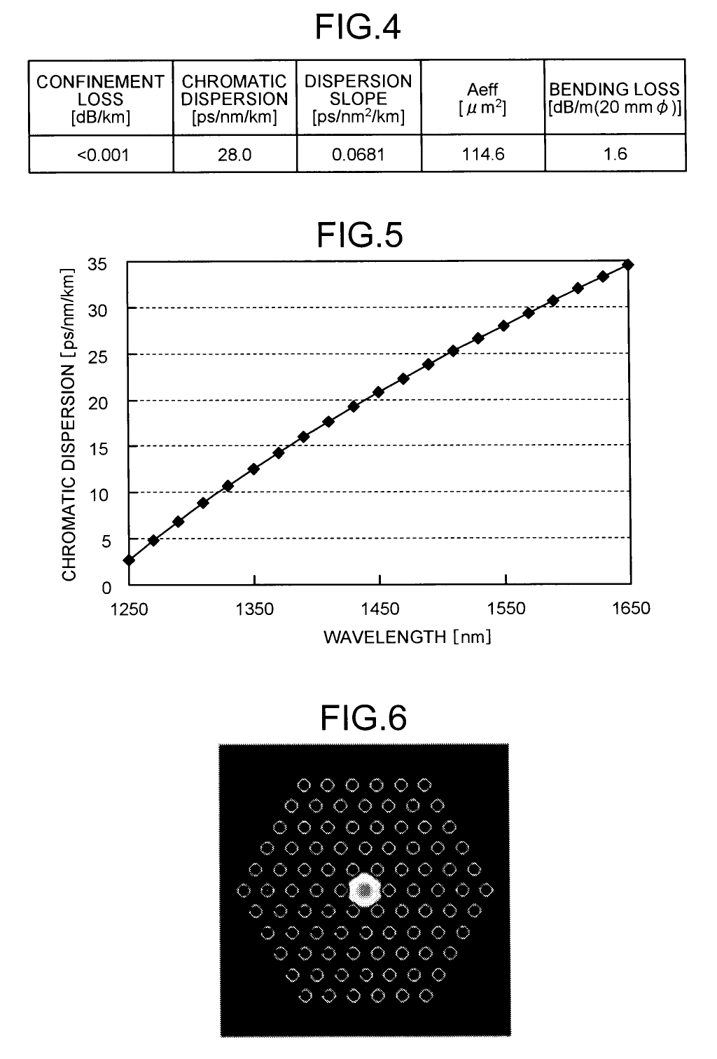

The holey fibers of Example 1 and Comparative Example 1 were manufactured with d/Λ of 0.50 and Λ of 10 micrometers where d is a diameter of the air hole and Λ is an air hole pitch. FIG. 4 is a table containing data of characteristics of the holey fiber having a structure shown in FIG. 1 calculated by a Finite Element Method (FEM) simulation at a wavelength of 1550 nanometers with d/Λ of 0.50 and Λ of 10 micrometers. Aeff shown in FIG. 4 means an effective core area. As shown in FIG. 4, the holey fiber has a relatively low chromatic dispersion value of 28 ps/nm/km, a large effective core area of 115 square micrometers, and sufficiently small bending loss. Thus, the holey fiber is suitable as an optical fiber for a transmission path. FIG. 5 is a graph of chromatic dispersion characteristics of the holey fiber shown in FIG. 4. The chromatic dispersion characteristics are similar to that of a standard single mode optical fiber. FIG. 6 is a schematic diagram of an optical field distribution (electric field x-component (Ex) distribution) in a cross section of the holey fiber shown in FIG. 4. The field distribution corresponds to a Gaussian field distribution with the core region as a center point.

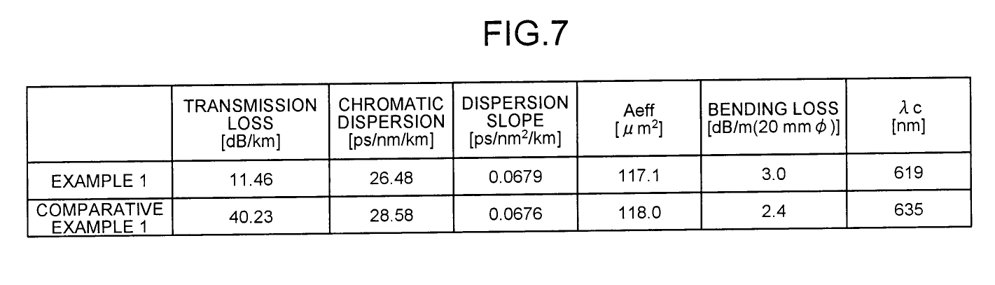

The characteristics of the holey fiber of Example 1 and Comparative Example 1 are described below. FIG. 7 is a table containing data of characteristics of the holey fibers according to Example 1 and Comparative Example 1. The characteristics shown in FIG. 7 are at the wavelength of 1550 nanometers other than a cut-off wavelength λc. The values of chromatic dispersion, dispersion slope, Aeff, and bending loss of the holey fibers of Example 1 and Comparative Example 1 are substantially the same as those shown in FIG. 4. The transmission loss of the holey fiber of Comparative Example 1 is 40.23 dB/km while that of the holey fiber of the Example 1 is 11.46 dB/km. Thus, transmission loss of the holey fiber of Example 1 is considerably lower than that of Comparative Example 1.

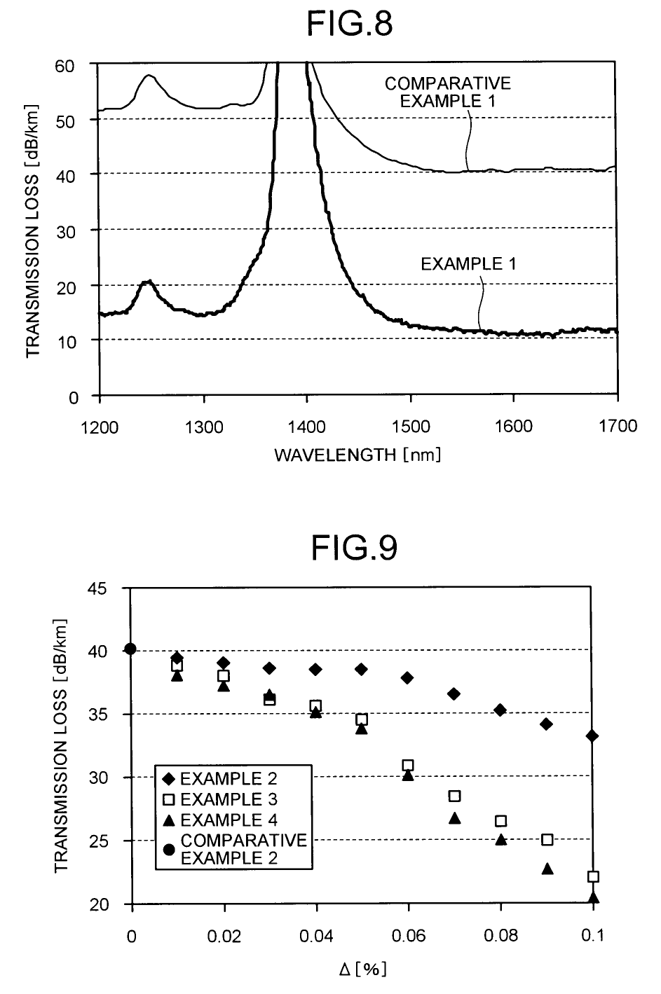

FIG. 8 is a graph of transmission loss verses wavelength of the holey fibers of Example 1 and Comparative Example 1. The holey fiber of the Example 1 has low transmission loss within a wider band of wavelengths compared to the holey fiber of Comparative Example 1.

As Example 2, a holey fiber having the same structure as that of the embodiment was manufacture by the stack and draw method. A glass rod and capillary tubes for forming air holes on a first layer counted from the glass rod were made of Ge-doped silica glass, and other capillary tubes and a jacket tube were made of pure silica glass. Ten holey fibers with each different amounts of Ge were doped into the glass rod and the capillary tubes were manufactured. Similarly, as Example 3, ten holey fibers were manufactured by using a glass rod made of Ge-doped silica glass and capillary tubes made of Ge-doped silica glass and used for forming air holes on a first layer and a second layer counted from the glass rod. As Example 4, ten holey fibers were manufactured by using a glass rod made of Ge-doped silica glass and capillary tubes made of Ge-doped silica glass and used for forming air holes on a first to a third layers counted from the glass rod. As Comparative Example 2, similar to Comparative Example 1, a holey fiber formed with a glass rod, capillary tubes, and a jacket tube made of pure silica glass was manufactured.

FIG. 9 is a graph of a relationship between a density of Ge in a glass rod and capillary tubes and a transmission loss of the holey fibers of each of Examples 2 to 4 and Comparative Example 2 at the wavelength of 1550 nanometers. The density of Ge is represented as relative refractive index difference Δ of Ge-doped silica glass. As shown in FIG. 9, every holey fiber of Examples 2 to 4 had larger Δ than that of the holey fiber of Comparative Example 2, and transmission loss decreased as the Ge density increased. Furthermore, the holey fibers of Examples 3 and 4 had lower transmission loss than that of the holey fiber of Example 2. Moreover, when Ge is doped with a density such that Δ of the glass rod and the capillary tubes become 0.05% or more, transmission loss was more effectively reduced. Assuming that only one dopant is used, transmission loss can be effectively reduced when changing Δ by Ge is 0.05% or more, changing Δ by F is about −0.017% or less, or changing Δ by Cl is about 0.009% or more.

As Example 5, a holey fiber having the same structure of Examples 1 to 4 was manufactured by the stack and draw method. A glass rod and capillary tubes for forming air holes on a first layer counted from the glass rod were made of Ge—F-doped silica glass, and other capillary tubes and a jacket tube were made of pure silica glass. Δ density of Ge to be doped was such that changing Δ by Ge to pure silica glass is by 0.02%, and a density of F was such that changing Δ by F to pure silica glass is by −0.02%.

As a result, the holey fiber manufactured in the above manner had a uniform refractive index over a core region and a cladding region with Δ of 0%. Transmission loss of the holey fiber at the wavelength of 1550 nanometers was reduced to about 25 dB/km.

According to the embodiment, the first and the second layers of the air holes 15 are formed within the inner cladding layer 12. However, the third and farther layers of the air holes 15 in which effect of propagation of a light is small can also be formed within the inner cladding layer 12.

The method of manufacturing the holey fiber 10 using the preform formed by the stack and draw method is described above. However, the preform can be formed by the drill method and the sol-gel method. For example, when employing the drill method, a preform is formed in such a manner that a glass rod having an inner layer and an outer layer with a viscosity higher than that of the inner layer is arranged, and air holes are formed in a layered structure in a region excluding a center region of the inner layer of the glass rod, that is, a core region, by using a drill.

According to the embodiment, it is possible to easily manufacture holey fibers with low transmission loss without improving control precision of gas pressure to be applied during the drawing process. It is needless to say that holey fibers with still lower transmission loss can be manufactured by precisely controlling the gas pressure.

According to an aspect of the present invention, it is possible to reduce occurrence of glass defect and distortion of the surface of the air holes in a region in which a light propagates. Therefore, it is possible to manufacture holey fibers with low transmission loss.

According to another aspect of the present invention, it is possible to reduce occurrence of glass defect and distortion of the surface of the air holes in a region in which a light propagates and easily prevent deformation of shapes of air holes without improving control precision of gas pressure to be applied. Therefore, it is possible to easily manufacture holey fibers with low transmission loss.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A holey fiber comprising:
a core region; and
a cladding region surrounding the core region and having air holes arranged around the core region, the cladding region including an inner cladding layer surrounding the core region and an outer cladding layer surrounding the inner cladding layer, wherein
viscosities of the core region and the inner cladding layer are lower than a viscosity of the outer cladding layer.

2. The holey fiber according to claim 1, wherein the air holes are arranged in a layered structure such that the air holes in a first layer and a second layer counted from the core region are within the inner cladding layer.

3. The holey fiber according to claim 1, wherein
the core region and the inner cladding layer are made of silica glass doped with at least one selected from a group consisting of chlorine, germanium, and fluorine, and
the outer cladding layer is made of pure silica glass.

4. The holey fiber according to claim 3, wherein the core region and the inner cladding layer are doped with germanium such that increase in a relative index difference of the core region and the inner cladding layer to the outer cladding layer is 0.05% or more by germanium doping.

5. The holey fiber according to claim 3, wherein the core region and the inner cladding layer are doped with chlorine such that increase in a relative index difference of the core region and the inner cladding layer to the outer cladding layer is 0.009% or more by chlorine doping.

6. The holey fiber according to claim 3, wherein the core region and the inner cladding layer are doped with fluorine such that increase in a relative index difference of the core region and the inner cladding layer to the outer cladding layer is 0.017% or more by fluorine doping.

7. The holey fiber according to claim 1, wherein the viscosities of the core region and the inner cladding layer at a temperature of 1200° C. are 13 poises or less.

8. A method of manufacturing a holey fiber including a core region and a cladding region surrounding the core region and having air holes arranged around the core region, the method comprising:
forming a preform by arranging a core rod at a center of a jacket tube and inner capillary tubes around the core rod; and
drawing the preform, wherein
viscosities of the core rod and the inner capillary tubes are lower than a viscosity of the jacket tube.

9. The method according to claim 8, wherein the forming includes arranging outer capillary tubes having viscosities higher than the viscosities of the core rod and the inner capillary tubes around the inner capillary tubes.

10. A method of manufacturing a holey fiber including a core region and a cladding region surrounding the core region and having air holes arranged around the core region, the method comprising:
forming a preform with air holes arranged in a region of a glass rod, the glass rod having an inner layer and an outer layer with a viscosity higher than a viscosity of the inner layer, and the region being other than a center region of the inner layer; and
drawing the preform.
